(19) United States
(12) Patent Application Publication
(10) Pub. No.: US 2022/0129343 A1
(43) Pub. Date: Apr. 28, 2022

(54) SYSTEMS AND METHODS FOR REDUCING EXCEPTION LATENCY

(71) Applicant: Dover Microsystems, Inc., Wayland, MA (US)

(72) Inventors: Steven Milburn, Cranston, RI (US); Gregory T. Sullivan, Rockport, MA (US)

(73) Assignee: Dover Microsystems, Inc., Wayland, MA (US)

(21) Appl. No.: 17/507,398

(22) Filed: Oct. 21, 2021

Related U.S. Application Data
(60) Provisional application No. 63/104,476, filed on Oct. 22, 2020.

(51) Int. Cl. G06F 11/07; G06F 11/34; G06F 9/38

(52) U.S. Cl. CPC G06F 11/0772; G06F 9/3861; G06F 11/3476; G06F 11/0781

(57) ABSTRACT

Systems and methods for reducing exception latency. In some embodiments, trace information regarding one or more instructions executed by a processor may be received. The trace information may indicate that the processor is entering an exception handling routine. A type of exception signal being handled by the processor may be determined based on the trace information. The type of exception signal being handled by the processor may then be used to determine whether to deactivate metadata processing. In response to determining that metadata processing is to be deactivated, state information may be updated to indicate that metadata processing is being deactivated.

### RELATED APPLICATION

This application claims priority under 35 U.S.C. § 119(e) to U.S. application No. 63/104,476, filed Oct. 22, 2020, entitled “SYSTEMS AND METHODS FOR REDUCING EXCEPTION LATENCY”, the contents of which is incorporated herein by reference in its entirety.

### BACKGROUND

Computer security has become an increasingly urgent concern at all levels of society, from individuals to businesses to government institutions. For example, in 2015, security researchers identified a zero-day vulnerability that would have allowed an attacker to hack into a Jeep Cherokee's on-board computer system via the Internet and take control of the vehicle's dashboard functions, steering, brakes, and transmission. In 2017, the WannaCry ransomware attack was estimated to have affected more than 200,000 computers worldwide, causing at least hundreds of millions of dollars in economic losses. Notably, the attack crippled operations at several National Health Service hospitals in the UK. In the same year, a data breach at Equifax, a US consumer credit reporting agency, exposed person data such as full names, social security numbers, birth dates, addresses, driver's license numbers, credit card numbers, etc. That attack is reported to have affected over 140 million consumers.

Security professionals are constantly playing catch-up with attackers. As soon as a vulnerability is reported, security professionals rush to patch the vulnerability. Individuals and organizations that fail to patch vulnerabilities in a timely manner (e.g., due to poor governance and/or lack of resources) become easy targets for attackers.

Some security software monitors activities on a computer and/or within a network, and looks for patterns that may be indicative of an attack. Such an approach does not prevent malicious code from being executed in the first place. Often, the damage has been done by the time any suspicious pattern emerges.

### SUMMARY

In accordance with some embodiments, a computer-implemented method is provided, comprising acts of: receiving trace information regarding one or more instructions executed by a processor, the trace information indicating that the processor is entering an exception handling routine; determining, based on the trace information, a type of exception signal being handled by the processor; determining, based on the type of exception signal being handled by the processor, whether to deactivate metadata processing; and in response to determining that metadata processing is to be deactivated, updating state information to indicate that metadata processing is being deactivated.

In accordance with some embodiments, a computer-implemented method is provided, comprising acts of: receiving trace information from a processor; determining a priority level for the trace information; selecting, based on the priority level for the trace information, a trace buffer from a plurality of trace buffers; and placing one or more instructions into the selected trace buffer, wherein: the one or more instructions are determined based on the trace information received from the processor.

In accordance with some embodiments, a computer-implemented method is provided, comprising acts of: fetching an instruction from a trace buffer of a plurality of trace buffers, wherein: each trace buffer of the plurality of trace buffers has an associated priority level; selecting, based on the priority level of the trace buffer from which the instruction is fetched, a set of one or more policies; and using the selected set of one or more policies to check the instruction.

In accordance with some embodiments, a computer-implemented method is provided, comprising acts of: fetching an instruction from a trace buffer of a plurality of trace buffers, wherein: each trace buffer of the plurality of trace buffers has an associated priority level; selecting, based on the priority level of the trace buffer from which the instruction is fetched, a metadata mapping; using the selected metadata mapping to obtain metadata; and using the obtained metadata to check the instruction.

In accordance with some embodiments, a system is provided, comprising circuitry and/or one or more processors programmed by executable instructions, wherein the circuitry and/or the one or more programmed processors are configured to perform any of the methods described herein.

In accordance with some embodiments, at least one computer-readable medium is provided, having stored thereon at least one netlist for any of the circuitries described herein.

In accordance with some embodiments, at least one computer-readable medium is provided, having stored thereon at least one hardware description that, when synthesized, produces any of the netlists described herein.

In accordance with some embodiments, at least one computer-readable medium is provided, having stored thereon any of the executable instructions described herein.

### BRIEF DESCRIPTION OF DRAWINGS

FIG. 1 shows an illustrative hardware system 100 for enforcing policies, in accordance with some embodiments.

FIG. 2 shows an illustrative software system 200 for enforcing policies, in accordance with some embodiments.

FIG. 3A shows an illustrative hardware interface 300, in accordance with some embodiments.

FIG. 3B shows the illustrative result queue 114 and the illustrative instruction queue 148 in the example of FIG. 3A, in accordance with some embodiments.

FIG. 4 shows an illustrative state machine 400 for managing metadata processing in response to exception signals, in accordance with some embodiments.

FIG. 5 shows illustrative trace buffers 500A-D and an illustrative exception priority stack 505, in accordance with some embodiments.

FIG. 6 shows the illustrative instruction queue 148 in the example of FIG. 3A, with a high latency threshold and a low latency threshold, in accordance with some embodiments.

FIG. 7 shows, schematically, an illustrative computer 1000 on which any aspect of the present disclosure may be implemented.

### DETAILED DESCRIPTION

Many vulnerabilities exploited by attackers trace back to a computer architectural design where data and executable instructions are intermingled in a same memory. This intermingling allows an attacker to inject malicious code into a remote computer by disguising the malicious code as data. For instance, a program may allocate a buffer in a computer's memory to store data received via a network. If the program receives more data than the buffer can hold, but does not check the size of the received data prior to writing the data into the buffer, part of the received data would be written beyond the buffer's boundary, into adjacent memory. An attacker may exploit this behavior to inject malicious code into the adjacent memory. If the adjacent memory is allocated for executable code, the malicious code may eventually be executed by the computer.

Techniques have been proposed to make computer hardware more security aware. For instance, memory locations may be associated with metadata for use in enforcing security policies, and instructions may be checked for compliance with the security policies. For example, given an instruction to be executed, metadata associated with the instruction and/or metadata associated with one or more operands of the instruction may be checked to determine if the instruction should be allowed. Additionally, or alternatively, appropriate metadata may be associated with an output of the instruction.

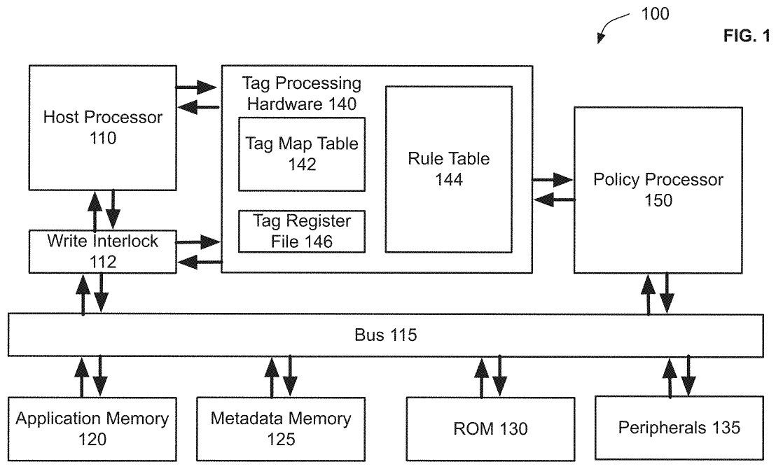

FIG. 1 shows an illustrative hardware system 100 for enforcing policies, in accordance with some embodiments. In this example, the system 100 includes a host processor 110, which may have any suitable instruction set architecture (ISA) such as a reduced instruction set computing (RISC) architecture or a complex instruction set computing (CISC) architecture. The host processor 110 may perform memory accesses via a write interlock 112. The write interlock 112 may be connected to a system bus 115 configured to transfer data between various components such as the write interlock 112, an application memory 120, a metadata memory 125, a read-only memory (ROM) 130, one or more peripherals 135, etc.

In some embodiments, data that is manipulated (e.g., modified, consumed, and/or produced) by the host processor 110 may be stored in the application memory 120. Such data may be referred to herein as “application data,” as distinguished from metadata used for enforcing policies. The latter may be stored in the metadata memory 125. It should be appreciated that application data may include data manipulated by an operating system (OS), instructions of the OS, data manipulated by one or more user applications, and/or instructions of the one or more user applications.

In some embodiments, the application memory 120 and the metadata memory 125 may be physically separate, and the host processor 110 may have no access to the metadata memory 125. In this manner, even if an attacker succeeds in injecting malicious code into the application memory 120 and causing the host processor 110 to execute the malicious code, the metadata memory 125 may not be affected. However, it should be appreciated that aspects of the present disclosure are not limited to storing application data and metadata on physically separate memories. Additionally, or alternatively, metadata may be stored in a same memory as application data, and a memory management component may be used that implements an appropriate protection scheme to prevent instructions executing on the host processor 110 from modifying the metadata. Additionally, or alternatively, metadata may be intermingled with application data in a same memory, and one or more policies may be used to protect the metadata.

In some embodiments, tag processing hardware 140 may be provided to ensure that instructions being executed by the host processor 110 comply with one or more policies. The tag processing hardware 140 may include any suitable circuit component or combination of circuit components. For instance, the tag processing hardware 140 may include a tag map table 142 that maps addresses in the application memory 120 to addresses in the metadata memory 125. For example, the tag map table 142 may map an address X in the application memory 120 to an address Y in the metadata memory 125. A value stored at the address Y is sometimes referred to herein as a “metadata tag.”

In some embodiments, a value stored at the address Y may in turn be an address Z. Such indirection may be repeated any suitable number of times, and may eventually lead to a data structure in the metadata memory 125 for storing metadata. Such metadata, as well as any intermediate address (e.g., the address Z), are also referred to herein as “metadata tags.”

It should be appreciated that aspects of the present disclosure are not limited to a tag map table that stores addresses in a metadata memory. In some embodiments, a tag map table entry itself may store metadata, so that the tag processing hardware 140 may be able to access the metadata without performing a memory operation. In some embodiments, a tag map table entry may store a selected bit pattern, where a first portion of the bit pattern may encode metadata, and a second portion of the bit pattern may encode an address in a metadata memory where further metadata may be stored. This may provide a desired balance between speed and expressivity. For instance, the tag processing hardware 140 may be able to check certain policies quickly, using only the metadata stored in the tag map table entry itself. For other policies with more complex rules, the tag processing hardware 140 may access the further metadata stored in the metadata memory 125.

Referring again to FIG. 1, by mapping application memory addresses to metadata memory addresses, the tag map table 142 may create an association between application data and metadata that describes the application data. In one example, metadata stored at the metadata memory address Y and thus associated with application data stored at the application memory address X may indicate that the application data may be readable, writable, and/or executable. In another example, metadata stored at the metadata memory address Y and thus associated with application data stored at the application memory address X may indicate a type of the application data (e.g., integer, pointer, 16-bit word, 32-bit word, etc.). Depending on a policy to be enforced, any suitable metadata relevant for the policy may be associated with a piece of application data.

In some embodiments, a metadata memory address Z may be stored at the metadata memory address Y. Metadata to be associated with the application data stored at the application memory address X may be stored at the metadata memory address Z, instead of (or in addition to) the metadata memory address Y. For instance, a binary representation of a metadata label RED may be stored at the metadata memory address Z. By storing the metadata memory address Z in the metadata memory address Y, the application data stored at the application memory address X may be tagged RED.

In this manner, the binary representation of the metadata label RED may be stored only once in the metadata memory 125. For instance, if application data stored at another application memory address X′ is also to be tagged RED, the tag map table 142 may map the application memory address X′ to a metadata memory address Y′ where the metadata memory address Z is also stored.

Moreover, in this manner, tag update may be simplified. For instance, if the application data stored at the application memory address X is to be tagged BLUE at a subsequent time, a metadata memory address Z′ may be written at the metadata memory address Y, to replace the metadata memory address Z, and a binary representation of the metadata label BLUE may be stored at the metadata memory address Z′.

Thus, the inventors have recognized and appreciated that a chain of metadata memory addresses of any suitable length N may be used for tagging, including N=0 (e.g., where a binary representation of a metadata label is stored at the metadata memory address Y itself).

The association between application data and metadata (also referred to herein as “tagging”) may be done at any suitable level of granularity, and/or variable granularity. For instance, tagging may be done on a word-by-word basis. Additionally, or alternatively, a region in memory may be mapped to a single metadata tag, so that all words in that region are associated with the same metadata. This may advantageously reduce a size of the tag map table 142 and/or the metadata memory 125. For example, a single metadata tag may be maintained for an entire address range, as opposed to maintaining multiple metadata tags corresponding, respectively, to different addresses in the address range.

In some embodiments, the tag processing hardware 140 may be configured to apply one or more rules to metadata associated with an instruction and/or metadata associated with one or more operands of the instruction to determine if the instruction should be allowed. For instance, the host processor 110 may fetch and execute an instruction (e.g., a store instruction), and may queue a result of executing the instruction (e.g., a value to be stored) into the write interlock 112. Before the result is written back into the application memory 120, the host processor 110 may send, to the tag processing hardware 140, an instruction type (e.g., opcode), an address where the instruction is stored, one or more memory addresses referenced by the instruction, and/or one or more register identifiers. Such a register identifier may identify a register used by the host processor 110 in executing the instruction, such as a register for storing an operand or a result of the instruction.

In some embodiments, destructive load instructions may be queued in addition to, or instead of, store instructions. For instance, subsequent instructions attempting to access a target address of a destructive load instruction may be queued in a memory region that is not cached. If and when it is determined that the destructive load instruction should be allowed, the queued instructions may be loaded for execution.

In some embodiments, a destructive load instruction may be allowed to proceed, and data read from a target address may be captured in a buffer. If and when it is determined that the destructive load instruction should be allowed, the data captured in the buffer may be discarded. If and when it is determined that the destructive load instruction should not be allowed, the data captured in the buffer may be restored to the target address. Additionally, or alternatively, a subsequent read may be serviced by the buffered data.

It should be appreciated that aspects of the present disclosure are not limited to performing metadata processing on instructions that have been executed by a host processor, such as instructions that have been retired by the host processor's execution pipeline. In some embodiments, metadata processing may be performed on instructions before, during, and/or after the host processor's execution pipeline.

In some embodiments, given an address received from the host processor 110 (e.g., an address where an instruction is stored, or an address referenced by an instruction), the tag processing hardware 140 may use the tag map table 142 to identify a corresponding metadata tag. Additionally, or alternatively, for a register identifier received from the host processor 110, the tag processing hardware 140 may access a metadata tag from a tag register file 146 within the tag processing hardware 140.

In some embodiments, if an application memory address does not have a corresponding entry in the tag map table 142, the tag processing hardware 140 may send a query to a policy processor 150. The query may include the application memory address in question, and the policy processor 150 may return a metadata tag for that application memory address. Additionally, or alternatively, the policy processor 150 may create a new tag map entry for an address range including the application memory address. In this manner, the appropriate metadata tag may be made available, for future reference, in the tag map table 142 in association with the application memory address in question.

In some embodiments, the tag processing hardware 140 may send a query to the policy processor 150 to check if an instruction executed by the host processor 110 should be allowed. The query may include one or more inputs, such as an instruction type (e.g., opcode) of the instruction, a metadata tag for a program counter, a metadata tag for an application memory address from which the instruction is fetched (e.g., a word in memory to which the program counter points), a metadata tag for a register in which an operand of the instruction is stored, and/or a metadata tag for an application memory address referenced by the instruction. In one example, the instruction may be a load instruction, and an operand of the instruction may be an application memory address from which application data is to be loaded. The query may include, among other things, a metadata tag for a register in which the application memory address is stored, as well as a metadata tag for the application memory address itself. In another example, the instruction may be an arithmetic instruction, and there may be two operands. The query may include, among other things, a first metadata tag for a first register in which a first operand is stored, and a second metadata tag for a second register in which a second operand is stored.

It should also be appreciated that aspects of the present disclosure are not limited to performing metadata processing on a single instruction at a time. In some embodiments, multiple instructions in a host processor's ISA may be checked together as a bundle, for example, via a single query to the policy processor 150. Such a query may include more inputs to allow the policy processor 150 to check all of the instructions in the bundle. Similarly, a CISC instruction, which may correspond semantically to multiple operations, may be checked via a single query to the policy processor 150, where the query may include sufficient inputs to allow the policy processor 150 to check all of the constituent operations within the CISC instruction.

In some embodiments, the policy processor 150 may include a configurable processing unit, such as a microprocessor, a field-programmable gate array (FPGA), and/or any other suitable circuitry. The policy processor 150 may have loaded therein one or more policies that describe allowed operations of the host processor 110. In response to a query from the tag processing hardware 140, the policy processor 150 may evaluate one or more of the policies to determine if an instruction in question should be allowed. For instance, the tag processing hardware 140 may send an interrupt signal to the policy processor 150, along with one or more inputs relating to the instruction in question (e.g., as described above). The policy processor 150 may store the inputs of the query in a working memory (e.g., in one or more queues) for immediate or deferred processing. For example, the policy processor 150 may prioritize processing of queries in some suitable manner (e.g., based on a priority flag associated with each query).

In some embodiments, the policy processor 150 may evaluate one or more policies on one or more inputs (e.g., one or more input metadata tags) to determine if an instruction in question should be allowed. If the instruction is not to be allowed, the policy processor 150 may so notify the tag processing hardware 140. If the instruction is to be allowed, the policy processor 150 may compute one or more outputs (e.g., one or more output metadata tags) to be returned to the tag processing hardware 140. As one example, the instruction may be a store instruction, and the policy processor 150 may compute an output metadata tag for an application memory address to which application data is to be stored. As another example, the instruction may be an arithmetic instruction, and the policy processor 150 may compute an output metadata tag for a register for storing a result of executing the arithmetic instruction.

In some embodiments, the policy processor 150 may be programmed to perform one or more tasks in addition to, or instead of, those relating to evaluation of policies. For instance, the policy processor 150 may perform tasks relating to tag initialization, boot loading, application loading, memory management (e.g., garbage collection) for the metadata memory 125, logging, debugging support, and/or interrupt processing. One or more of these tasks may be performed in the background (e.g., between servicing queries from the tag processing hardware 140).

In some embodiments, the tag processing hardware 140 may include a rule table 144 for mapping one or more inputs to a decision and/or one or more outputs. For instance, a query into the rule table 144 may be similarly constructed as a query to the policy processor 150 to check if an instruction executed by the host processor 110 should be allowed. If there is a match, the rule table 144 may output a decision as to whether to the instruction should be allowed, and/or one or more output metadata tags (e.g., as described above in connection with the policy processor 150). Such a mapping in the rule table 144 may be created using a query response from the policy processor 150. However, that is not required, as in some embodiments, one or more mappings may be installed into the rule table 144 ahead of time.

In some embodiments, the rule table 144 may be used to provide a performance enhancement. For instance, before querying the policy processor 150 with one or more input metadata tags, the tag processing hardware 140 may first query the rule table 144 with the one or more input metadata tags. In case of a match, the tag processing hardware 140 may proceed with a decision and/or one or more output metadata tags from the rule table 144, without querying the policy processor 150. This may provide a significant speedup.

If, on the other hand, there is no match, the tag processing hardware 140 may query the policy processor 150, and may install a response from the policy processor 150 into the rule table 144 for potential future use. Thus, the rule table 144 may function as a cache. However, it should be appreciated that aspects of the present disclosure are not limited to implementing the rule table 144 as a cache.

In some embodiments, the tag processing hardware 140 may form a hash key based on one or more input metadata tags, and may present the hash key to the rule table 144. If there is no match, the tag processing hardware 140 may send an interrupt signal to the policy processor 150. In response to the interrupt signal, the policy processor 150 may fetch metadata from one or more input registers (e.g., where the one or more input metadata tags are stored), process the fetched metadata, and write one or more results to one or more output registers. The policy processor 150 may then signal to the tag processing hardware 140 that the one or more results are available.

In some embodiments, if the tag processing hardware 140 determines that an instruction (e.g., a store instruction) in question should be allowed (e.g., based on a hit in the rule table 144, or a miss in the rule table 144, followed by a response from the policy processor 150 indicating no policy violation has been found), the tag processing hardware 140 may indicate to the write interlock 112 that a result of executing the instruction (e.g., a value to be stored) may be written back to memory. Additionally, or alternatively, the tag processing hardware 140 may update the metadata memory 125, the tag map table 142, and/or the tag register file 146 with one or more output metadata tags (e.g., as received from the rule table 144 or the policy processor 150). As one example, for a store instruction, the metadata memory 125 may be updated based on an address translation by the tag map table 142. For instance, an application memory address referenced by the store instruction may be used to look up a metadata memory address from the tag map table 142, and metadata received from the rule table 144 or the policy processor 150 may be stored to the metadata memory 125 at the metadata memory address. As another example, where metadata to be updated is stored in an entry in the tag map table 142 (as opposed to being stored in the metadata memory 125), that entry in the tag map table 142 may be updated. As another example, for an arithmetic instruction, an entry in the tag register file 146 corresponding to a register used by the host processor 110 for storing a result of executing the arithmetic instruction may be updated with an appropriate metadata tag.

In some embodiments, if the tag processing hardware 140 determines that the instruction in question represents a policy violation (e.g., based on a miss in the rule table 144, followed by a response from the policy processor 150 indicating a policy violation has been found), the tag processing hardware 140 may indicate to the write interlock 112 that a result of executing the instruction should be discarded, instead of being written back to memory. Additionally, or alternatively, the tag processing hardware 140 may send an interrupt to the host processor 110. In response to receiving the interrupt, the host processor 110 may switch to any suitable violation processing code. For example, the host processor 100 may halt, reset, log the violation and continue, perform an integrity check on application code and/or application data, notify an operator, etc.

In some embodiments, the rule table 144 may be implemented with a hash function and a designated portion of a memory (e.g., the metadata memory 125). For instance, a hash function may be applied to one or more inputs to the rule table 144 to generate an address in the metadata memory 125. A rule table entry corresponding to the one or more inputs may be stored to, and/or retrieved from, that address in the metadata memory 125. Such an entry may include the one or more inputs and/or one or more corresponding outputs, which may be computed from the one or more inputs at run time, load time, link time, or compile time.

In some embodiments, the tag processing hardware 140 may include one or more configuration registers. Such a register may be accessible (e.g., by the policy processor 150) via a configuration interface of the tag processing hardware 140. In some embodiments, the tag register file 146 may be implemented as configuration registers. Additionally, or alternatively, there may be one or more application configuration registers and/or one or more metadata configuration registers.

Although details of implementation are shown in FIG. 1 and described above, it should be appreciated that aspects of the present disclosure are not limited to the use of any particular component, or combination of components, or to any particular arrangement of components. For instance, in some embodiments, one or more functionalities of the policy processor 150 may be performed by the host processor 110. As an example, the host processor 110 may have different operating modes, such as a user mode for user applications and a privileged mode for an operating system. Policy-related code (e.g., tagging, evaluating policies, etc.) may run in the same privileged mode as the operating system, or a different privileged mode (e.g., with even more protection against privilege escalation).

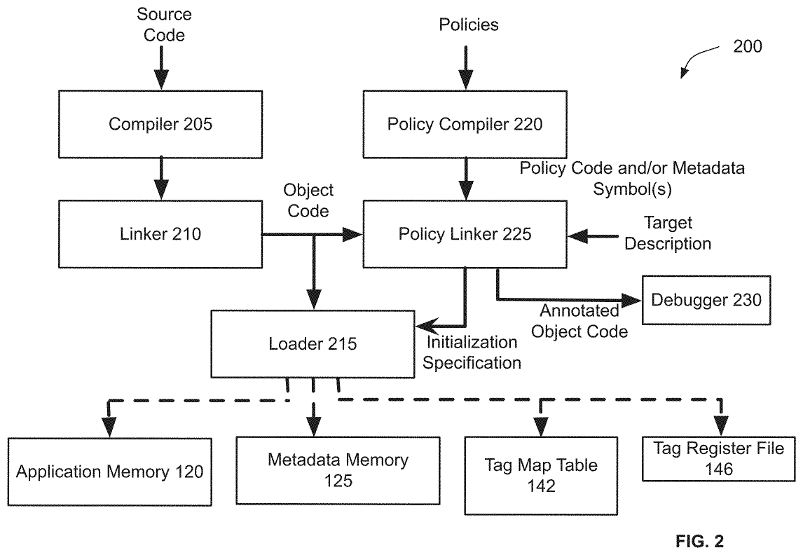

FIG. 2 shows an illustrative software system 200 for enforcing policies, in accordance with some embodiments. For instance, the software system 200 may be programmed to generate executable code and/or load the executable code into the illustrative hardware system 100 in the example of FIG. 1.

In the example shown in FIG. 2, the software system 200 includes a software toolchain having a compiler 205, a linker 210, and a loader 215. The compiler 205 may be programmed to process source code into executable code, where the source code may be in a higher-level language and the executable code may be in a lower level language. The linker 210 may be programmed to combine multiple object files generated by the compiler 205 into a single object file to be loaded by the loader 215 into memory (e.g., the illustrative application memory 120 in the example of FIG. 1). Although not shown, the object file output by the linker 210 may be converted into a suitable format and stored in persistent storage, such as flash memory, hard disk, read-only memory (ROM), etc. The loader 215 may retrieve the object file from the persistent storage, and load the object file into random-access memory (RAM).

In some embodiments, the compiler 205 may be programmed to generate information for use in enforcing policies. For instance, as the compiler 205 translates source code into executable code, the compiler 205 may generate information regarding data types, program semantics and/or memory layout. As one example, the compiler 205 may be programmed to mark a boundary between one or more instructions of a function and one or more instructions that implement calling convention operations (e.g., passing one or more parameters from a caller function to a callee function, returning one or more values from the callee function to the caller function, storing a return address to indicate where execution is to resume in the caller function's code when the callee function returns control back to the caller function, etc.). Such boundaries may be used, for instance, during initialization to tag certain instructions as function prologue or function epilogue. At run time, a stack policy may be enforced so that, as function prologue instructions execute, certain locations in a call stack (e.g., where a return address is stored) may be tagged as FRAME locations, and as function epilogue instructions execute, the FRAME metadata tags may be removed. The stack policy may indicate that instructions implementing a body of the function (as opposed to function prologue and function epilogue) only have read access to FRAME locations. This may prevent an attacker from overwriting a return address and thereby gaining control.

As another example, the compiler 205 may be programmed to perform control flow analysis, for instance, to identify one or more control transfer points and respective destinations. Such information may be used in enforcing a control flow policy. As yet another example, the compiler 205 may be programmed to perform type analysis, for example, by applying type labels such as Pointer, Integer, Floating-Point Number, etc. Such information may be used to enforce a policy that prevents misuse (e.g., using a floating-point number as a pointer).

Although not shown in FIG. 2, the software system 200 may, in some embodiments, include a binary analysis component programmed to take, as input, object code produced by the linker 210 (as opposed to source code), and perform one or more analyses similar to those performed by the compiler 205 (e.g., control flow analysis, type analysis, etc.).

In the example of FIG. 2, the software system 200 further includes a policy compiler 220 and a policy linker 225. The policy compiler 220 may be programmed to translate one or more policies written in a policy language into policy code. For instance, the policy compiler 220 may output policy code in C or some other suitable programming language. Additionally, or alternatively, the policy compiler 220 may output one or more metadata labels referenced by the one or more policies. At initialization, such a metadata label may be associated with one or more memory locations, registers, and/or other machine state of a target system, and may be resolved into a binary representation of metadata to be loaded into a metadata memory or some other hardware storage (e.g., registers) of the target system. As described above, such a binary representation of metadata, or a pointer to a location at which the binary representation is stored, is sometimes referred to herein as a “metadata tag.”

It should be appreciated that aspects of the present disclosure are not limited to resolving metadata labels at load time. In some embodiments, one or more metadata labels may be resolved statically (e.g., at compile time or link time). For example, the policy compiler 220 may process one or more applicable policies, and resolve one or more metadata labels defined by the one or more policies into a statically-determined binary representation. Additionally, or alternatively, the policy linker 225 may resolve one or more metadata labels into a statically-determined binary representation, or a pointer to a data structure storing a statically-determined binary representation. The inventors have recognized and appreciated that resolving metadata labels statically may advantageously reduce load time processing. However, aspects of the present disclosure are not limited to resolving metadata labels in any particular manner.

In some embodiments, the policy linker 225 may be programmed to process object code (e.g., as output by the linker 210), policy code (e.g., as output by the policy compiler 220), and/or a target description, to output an initialization specification. The initialization specification may be used by the loader 215 to securely initialize a target system having one or more hardware components (e.g., the illustrative hardware system 100 in the example of FIG. 1) and/or one or more software components (e.g., an operating system, one or more user applications, etc.).

In some embodiments, the target description may include descriptions of a plurality of named entities. A named entity may represent a component of a target system. As one example, a named entity may represent a hardware component, such as a configuration register, a program counter, a register file, a timer, a status flag, a memory transfer unit, an input/output device, etc. As another example, a named entity may represent a software component, such as a function, a module, a driver, a service routine, etc.

In some embodiments, the policy linker 225 may be programmed to search the target description to identify one or more entities to which a policy pertains. For instance, the policy may map certain entity names to corresponding metadata labels, and the policy linker 225 may search the target description to identify entities having those entity names. The policy linker 225 may identify descriptions of those entities from the target description, and use the descriptions to annotate, with appropriate metadata labels, the object code output by the linker 210. For instance, the policy linker 225 may apply a Read label to a .rodata section of an Executable and Linkable Format (ELF) file, a Read label and a Write label to a .data section of the ELF file, and an Execute label to a .text section of the ELF file. Such information may be used to enforce a policy for memory access control and/or executable code protection (e.g., by checking read, write, and/or execute privileges).

It should be appreciated that aspects of the present disclosure are not limited to providing a target description to the policy linker 225. In some embodiments, a target description may be provided to the policy compiler 220, in addition to, or instead of, the policy linker 225. The policy compiler 220 may check the target description for errors. For instance, if an entity referenced in a policy does not exist in the target description, an error may be flagged by the policy compiler 220. Additionally, or alternatively, the policy compiler 220 may search the target description for entities that are relevant for one or more policies to be enforced, and may produce a filtered target description that includes entities descriptions for the relevant entities only. For instance, the policy compiler 220 may match an entity name in an “init” statement of a policy to be enforced to an entity description in the target description, and may remove from the target description (or simply ignore) entity descriptions with no corresponding “init” statement.

In some embodiments, the loader 215 may initialize a target system based on an initialization specification produced by the policy linker 225. For instance, referring to the example of FIG. 1, the loader 215 may load data and/or instructions into the application memory 120, and may use the initialization specification to identify metadata labels associated with the data and/or instructions being loaded into the application memory 120. The loader 215 may resolve the metadata labels in the initialization specification into respective binary representations. However, it should be appreciated that aspects of the present disclosure are not limited to resolving metadata labels at load time. In some embodiments, a universe of metadata labels may be known during policy linking, and therefore metadata labels may be resolved at that time, for example, by the policy linker 225. This may advantageously reduce load time processing of the initialization specification.

In some embodiments, the policy linker 225 and/or the loader 215 may maintain a mapping of binary representations of metadata back to human readable versions of metadata labels. Such a mapping may be used, for example, by a debugger 230. For instance, in some embodiments, the debugger 230 may be provided to display a human readable version of an initialization specification, which may list one or more entities and, for each entity, a set of one or more metadata symbols associated with the entity. Additionally, or alternatively, the debugger 230 may be programmed to display assembly code annotated with metadata labels, such as assembly code generated by disassembling object code annotated with metadata labels. During debugging, the debugger 230 may halt a program during execution, and allow inspection of entities and/or metadata tags associated with the entities, in human readable form. For instance, the debugger 230 may allow inspection of entities involved in a policy violation and/or metadata tags that caused the policy violation. The debugger 230 may do so using the mapping of binary representations of metadata back to metadata labels.

In some embodiments, a conventional debugging tool may be extended to allow review of issues related to policy enforcement, for example, as described above. Additionally, or alternatively, a stand-alone policy debugging tool may be provided.

In some embodiments, the loader 215 may load the binary representations of the metadata labels into the metadata memory 125, and may record the mapping between application memory addresses and metadata memory addresses in the tag map table 142. For instance, the loader 215 may create an entry in the tag map table 142 that maps an application memory address where an instruction is stored in the application memory 120, to a metadata memory address where metadata associated with the instruction is stored in the metadata memory 125. Additionally, or alternatively, the loader 215 may store metadata in the tag map table 142 itself (as opposed to the metadata memory 125), to allow access without performing any memory operation.

In some embodiments, the loader 215 may initialize the tag register file 146 in addition to, or instead of, the tag map table 142. For instance, the tag register file 146 may include a plurality of registers corresponding, respectively, to a plurality of entities. The loader 215 may identify, from the initialization specification, metadata associated with the entities, and store the metadata in the respective registers in the tag register file 146.

Referring again to the example of FIG. 1, the loader 215 may, in some embodiments, load policy code (e.g., as output by the policy compiler 220) into the metadata memory 125 for execution by the policy processor 150. Additionally, or alternatively, a separate memory (not shown in FIG. 1) may be provided for use by the policy processor 150, and the loader 215 may load policy code and/or associated data into the separate memory.

In some embodiments, a metadata label may be based on multiple metadata symbols. For instance, an entity may be subject to multiple policies, and may therefore be associated with different metadata symbols corresponding, respectively, to the different policies. The inventors have recognized and appreciated that it may be desirable that a same set of metadata symbols be resolved by the loader 215 to a same binary representation (which is sometimes referred to herein as a “canonical” representation). For instance, a metadata label {A, B, C} and a metadata label {B, A, C} may be resolved by the loader 215 to a same binary representation. In this manner, metadata labels that are syntactically different but semantically equivalent may have the same binary representation.

The inventors have further recognized and appreciated it may be desirable to ensure that a binary representation of metadata is not duplicated in metadata storage. For instance, as described above, the illustrative rule table 144 in the example of FIG. 1 may map input metadata tags to output metadata tags, and, in some embodiments, the input metadata tags may be metadata memory addresses where binary representations of metadata are stored, as opposed to the binary representations themselves. The inventors have recognized and appreciated that if a same binary representation of metadata is stored at two different metadata memory addresses X and Y, the rule table 144 may not recognize an input pattern having the metadata memory address Y as matching a stored mapping having the metadata memory address X. This may result in a large number of unnecessary rule table misses, which may degrade system performance.

Moreover, the inventors have recognized and appreciated that having a one-to-one correspondence between binary representations of metadata and their storage locations may facilitate metadata comparison. For instance, equality between two pieces of metadata may be determined simply by comparing metadata memory addresses, as opposed to comparing binary representations of metadata. This may result in significant performance improvement, especially where the binary representations are large (e.g., many metadata symbols packed into a single metadata label).

Accordingly, in some embodiments, the loader 215 may, prior to storing a binary representation of metadata (e.g., into the illustrative metadata memory 125 in the example of FIG. 1), check if the binary representation of metadata has already been stored. If the binary representation of metadata has already been stored, instead of storing it again at a different storage location, the loader 215 may refer to the existing storage location. Such a check may be done at startup and/or when a program is loaded subsequent to startup (with or without dynamic linking).

Additionally, or alternatively, a similar check may be performed when a binary representation of metadata is created as a result of evaluating one or more policies (e.g., by the illustrative policy processor 150 in the example of FIG. 1). If the binary representation of metadata has already been stored, a reference to the existing storage location may be used (e.g., installed in the illustrative rule table 144 in the example of FIG. 1).

In some embodiments, the loader 215 may create a hash table mapping hash values to storage locations. Before storing a binary representation of metadata, the loader 215 may use a hash function to reduce the binary representation of metadata into a hash value, and check if the hash table already contains an entry associated with the hash value. If so, the loader 215 may determine that the binary representation of metadata has already been stored, and may retrieve, from the entry, information relating to the binary representation of metadata (e.g., a pointer to the binary representation of metadata, or a pointer to that pointer). If the hash table does not already contain an entry associated with the hash value, the loader 215 may store the binary representation of metadata (e.g., to a register or a location in a metadata memory), create a new entry in the hash table in association with the hash value, and store appropriate information in the new entry (e.g., a register identifier, a pointer to the binary representation of metadata in the metadata memory, a pointer to that pointer, etc.). However, it should be appreciated that aspects of the present disclosure are not limited to the use of a hash table for keeping track of binary representations of metadata that have already been stored. Additionally, or alternatively, other data structures may be used, such as a graph data structure, an ordered list, an unordered list, etc. Any suitable data structure or combination of data structures may be selected based on any suitable criterion or combination of criteria, such as access time, memory usage, etc.

It should be appreciated that the techniques introduced above and/or described in greater detail below may be implemented in any of numerous ways, as these techniques are not limited to any particular manner of implementation. Examples of implementation details are provided herein solely for purposes of illustration. Furthermore, the techniques disclosed herein may be used individually or in any suitable combination, as aspects of the present disclosure are not limited to any particular technique or combination of techniques.

For instance, while examples are described herein that include a compiler (e.g., the illustrative compiler 205 and/or the illustrative policy compiler 220 in the example of FIG. 2), it should be appreciated that aspects of the present disclosure are not limited to using a compiler. In some embodiments, a software toolchain may be implemented as an interpreter. For example, a lazy initialization scheme may be implemented, where one or more default labels (e.g., DEFAULT, PLACEHOLDER, etc.) may be used for tagging at startup, and a policy processor (e.g., the illustrative policy processor 150 in the example of FIG. 1) may evaluate one or more policies and resolve the one or more default labels in a just-in-time manner.

As described above in connection with the example of FIG. 1, one or more instructions executed by the illustrative host processor 110 may be checked by the illustrative tag processing hardware 140 to determine if the one or more instructions should be allowed. In some embodiments, the one or more instructions may be placed in a queue of instructions to be checked by the tag processing hardware 140. Additionally, or alternatively, a result of executing the one or more instructions may be placed in a queue of the illustrative write interlock 112 while the tag processing hardware 140 checks the one or more instructions. If the tag processing hardware 140 determines that the one or more instructions should be allowed, the result may be released from the queue of the write interlock 112 and written into the illustrative application memory 120.

In some instances, a result queue of the write interlock 112 and/or an instruction queue of the tag processing hardware 140 may become full. When that occurs, an execution result may be written into the application memory 120, even though one or more corresponding instructions have not been checked by the tag processing hardware 140. This may create a security vulnerability. For instance, an attacker may cause the host processor 110 to execute a large number of instructions in quick succession, so as to fill up the result queue and/or the instruction queue. The attacker may then cause execution of malicious code that otherwise would have been disallowed by the tag processing hardware 140. To avoid such an attack, it may be desirable to stall the host processor 110 temporarily to allow the tag processing hardware 140 to catch up.

In some embodiments, stalling may be effectuated by preventing the host processor 110 from accessing the application memory 120. For instance, when the result queue of the write interlock 112 is filled to a selected threshold level, a signal may be triggered to cause a bus to stop responding to the host processor's memory access requests. Additionally, or alternatively, a similar signal may be triggered when the instruction queue of the tag processing hardware 140 is filled to a selected threshold level. In this manner, the tag processing hardware 140 may check instructions already executed by the host processor while the host processor 110 waits for the bus to respond.

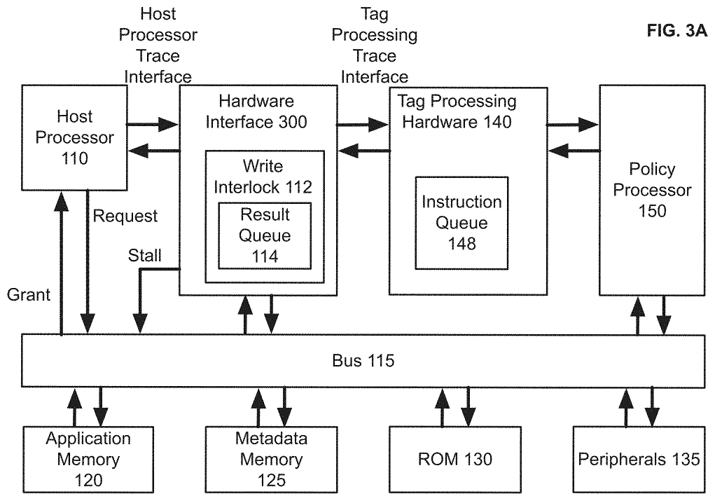

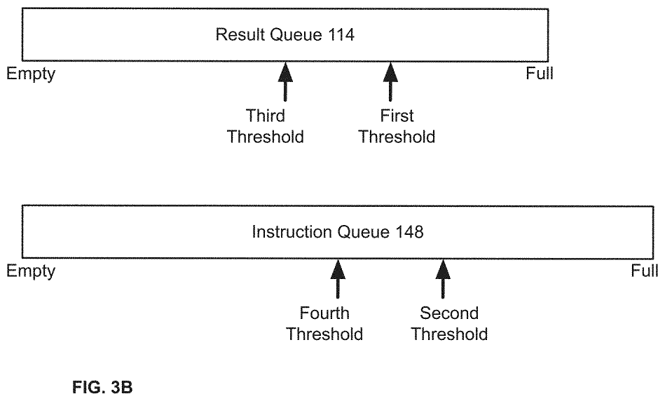

FIG. 3A shows an illustrative hardware interface 300, in accordance with some embodiments. The hardware interface 300 may coordinate interactions between a host processor (e.g., the illustrative host processor 110 in the example of FIG. 1) and tag processing hardware (e.g., the illustrative tag processing hardware 140 in the example of FIG. 1). For instance, the hardware interface 300 may transform an instruction in an ISA of the host processor 110 into one or more instructions in an ISA of the tag processing hardware 140. Illustrative techniques for transforming instructions are described in International Patent Application No. PCT/US2019/016276, filed on Feb. 1, 2019, entitled “SYSTEMS AND METHODS FOR TRANSFORMING INSTRUCTIONS FOR METADATA PROCESSING,” which is incorporated herein by reference in its entirety. However, it should be appreciated that aspects of the present disclosure are not limited to any particular technique for instruction transformation, or to any instruction transformation at all.

In some embodiments, the host processor 110 may, via a host processor trace interface, inform the hardware interface 300 that an instruction has been executed by the host processor 110. The hardware interface 300 may in turn inform the tag processing hardware 140 via a tag processing trace interface. The tag processing hardware 140 may place an instruction (which may have been received directly from the host processor 110, or may be a result of instruction transformation performed the hardware interface 300) in an instruction queue 148, which may hold instructions to be checked by the tag processing hardware 140 and/or a policy processor (e.g., the illustrative policy processor 150 in the example of FIG. 1).

In some embodiments, the hardware interface 300 may include a write interlock (e.g., the illustrative write interlock 112 in the example of FIG. 1). Illustrative techniques for write interlocking are described in International Patent Application No. PCT/US2019/016317, filed on Feb. 1, 2019, entitled “SYSTEMS AND METHODS FOR POST CACHE INTERLOCKING,” which is incorporated herein by reference in its entirety. However, it should be appreciated that aspects of the present disclosure are not limited to any particular technique for write interlocking, or to any write interlocking at all.

The inventors have recognized and appreciated that write interlock designs may be adapted to be compatible with different host processor designs. Therefore, it may be desirable to include the write interlock 112 as part of the hardware interface 300, so that the tag processing hardware 140 may be provided in a manner that is independent of host processor design. However, it should be appreciated that aspects of the present disclosure are not limited to any particular component, or any particular arrangement of components. In some embodiments, the write interlock 112 may be part of the tag processing hardware 140. Additionally, or alternatively, any one or more functionalities described herein in connection with the hardware interface 300 may be performed by the tag processing hardware 140.

In some embodiments, the write interlock 112 may include a result queue 114 for storing execution results while instructions that produced the results are being checked by the tag processing hardware 140 and/or the policy processor 150. If an instruction is allowed (e.g., a store instruction), a corresponding result (e.g., a value to be stored) may be released from the result queue 114 and written into an application memory (e.g., the illustrative application memory 120 in the example of FIG. 1).

In some embodiments, the host processor 110 may access the application memory 120 via a bus 115. The bus 115 may implement any suitable protocol, such as Advanced eXtensible Interface (AXI). For instance, to read an instruction or a piece of data from the application memory 120, the host processor 110 may send a read request to the bus 115 with an address where the instruction or data is stored. The bus 115 may perform a handshake, for example, by asserting a VALID signal at a processor-side interface and a READY signal at a memory-side interface. When both signals are high, the address may be transmitted to the application memory 120. When the application memory 120 returns the requested instruction or data, the bus 115 may perform another handshake, for example, by asserting a VALID signal at the memory-side interface and a READY signal at the processor-side interface. When both signals are high, the requested instruction or data may be transmitted to the host processor 110.

Additionally, or alternatively, to write an instruction or a piece of data to the application memory 120, the host processor 110 may send a write request to the bus 115 with an address where the instruction or data is to be written. The bus 115 may perform a first handshake, for example, by asserting a VALID signal at a processor-side interface and a READY signal at a memory-side interface. When both signals are high, the address may be transmitted to the application memory 120. The bus 115 may perform a second handshake, for example, by asserting a VALID signal at the processor-side interface and a READY signal at the memory-side interface. When both signals are high, the instruction or data to be written may be transmitted to the application memory 120. When the application memory 120 responds with an acknowledgment that the instruction or data has been written at the indicated address, the bus 115 may perform a third handshake, for example, by asserting a VALID signal at the memory-side interface and a READY signal at the processor-side interface. When both signals are high, the acknowledgment may be transmitted to the host processor 110.

As described above, it may, in some instances, be desirable to stall the host process 110 (e.g., to allow the tag processing hardware 140 to catch up). The inventors have recognized and appreciated that the host processor 110 may be stalled by asserting a stall signal to cause the bus 115 to stop responding to memory access requests from the host processor 110.

FIG. 3B shows illustrative first and third threshold levels for the illustrative result queue 114 in the example of FIG. 3A, as well as illustrative second and fourth threshold levels for the illustrative instruction queue 148 in the example of FIG. 3A, in accordance with some embodiments. One or more of these thresholds may be used to determine when to assert or de-assert a stall signal at the bus 115.

In some embodiments, the hardware interface 300 may determine that the tag processing hardware 140 is falling behind the host processor 110. For example, the hardware interface 300 may determine that the result queue 114 of the write interlock 112 is filled to a first threshold level, or that the instruction queue 148 of the tag processing hardware 140 is filled to a second threshold level. In response, the hardware interface 300 may send a STALL signal to the bus 115, which may use the STALL signal to gate a VALID signal and/or a READY signal in a handshake. This may prevent the handshake from being successful until the STALL signal is de-asserted, which may happen when the result queue 114 drops below a third threshold level (which may be lower than the first threshold level), or when the instruction queue 148 drops below a fourth threshold level (which may be lower than the second threshold level).

Although details of implementation are shown in FIGS. 3A-B and described above, it should be appreciated that aspects of the present disclosure are not limited to any particular manner of implementation. For instance, in some embodiments, a man-in-the-middle approach may be used instead of, or in addition to, gating a bus handshake. For example, a hardware component may be inserted between the host processor 110 and the bus 115. The hardware component may accept from the host processor 110 a request with an address from which an instruction or a piece data is to be read (or to which an instruction or a piece data is to be written), but may refrain from forwarding the address to the bus 115 until the tag processing hardware 140 has caught up.

It should also be appreciated that not all components may be shown in FIGS. 3A-B. For instance, the tag processing hardware 140 may include one or more components (e.g., the illustrative tag map table 142, rule table 144, and/or tag register file 146 in the example of FIG. 1) in addition to, or instead of the instruction queue 148.

The inventors have recognized and appreciated that, while stalling the host processor 110 may allow the tag processing hardware 140 to catch up, some technical challenges may arise as a result. For instance, when stalled, the host processor 110 may be unable to handle exceptions that are not related to metadata processing. This may increase exception latency to tens, hundreds, or even thousands of cycles. It may be desirable to decrease such latency, for example, for selected types of exceptions (e.g., selected types of interrupts).

Accordingly, in some embodiments, techniques are provided for reducing exception latency. For instance, selected exception handler code may be deemed trusted, and may be allowed to execute without being checked by the tag processing hardware 140. Such trusted exception handler code may be selected in any suitable manner. As one example, a configuration file may be provided that indicates one or more exception signals for which exception handler code may be deemed trusted. As another example, each exception signal expected by the host processor 110 may have an associated priority level, and a configuration file may be provided that indicates a threshold priority level as being sensitive to latency. If an exception signal has a priority level that is equal to or higher than the indicated threshold priority level, exception handler code for that exception signal may be deemed trusted.

In some embodiments, a configuration file may be provided as part of a target description that is used by a policy linker (e.g., the illustrative policy linker 225 in the example of FIG. 2) to generate an initialization specification. The initialization specification may in turn be used by a policy processor (e.g., the illustrative policy processor 150 in the example of FIG. 1) to configure one or more registers in the tag processing hardware 140 with information indicative of one or more exception handlers that are allowed to execute without being checked by the tag processing hardware 140.

It should be appreciated that aspects of the present disclosure are not limited to using a configuration file to identify exception handlers that are allowed to execute without being checked by tag processing hardware, or to identifying such exception handlers at all. For instance, with reference to the example of FIG. 1, code fetched from one or more designated address ranges in the application memory 120 may be deemed trusted. When the host processor 110 is supposed to be stalled to allow the tag processing hardware 140 to catch up, such code may be allowed to execute without being checked by the tag processing hardware 140. Additionally, or alternatively, code that is deemed trusted may be associated with metadata that so indicates (e.g., by storing such metadata at a location in the metadata memory 125 that is mapped by the tag map table 142 to a location in the application memory 120 at which the code is stored). The tag processing hardware 140 may be configured (e.g., via hardware logic and/or one or more rules installed in the rule table 144) to allow code associated with such metadata to execute without being checked when the host processor 110 is supposed to be stalled.

However, the inventors have recognized and appreciated that allowing code to be executed without being checked by the tag processing hardware 140 may have some impact on security, even if this happens only when the host processor 110 is supposed to be stalled to allow the tag processing hardware 140 to catch up, and even if there is only a limited amount of such code (e.g., selected exception handler code). For instance, malicious code may load data from an application memory location into a register in violation of a privacy policy, and then trigger an exception. The exception handler code may access the register, and may push the loaded data to another application memory location (e.g., via a store instruction of the exception handler code). If the exception handler code is allowed to execute before the load instruction is checked, a policy violation may go undetected.¹ ¹ This risk may be mitigated if the exception handler code only communicates through memory, because a write interlock (e.g., the illustrative write interlock 112 in the example of FIG. 1) may be used to ensure that no data may be stored to memory until all instructions leading to, and including, the store instruction have been checked.

Accordingly, in some embodiments, techniques are provided for checking instructions out of order, so that one or more instructions that are sensitive to latency may be checked before one or more other instructions, even if the one or more other instructions have been executed earlier by the host processor 110.

For instance, in some embodiments, multiple instruction queues may be provided to hold instructions to be checked by the tag processing hardware 140 and/or the policy processor 150, where each instruction queue may correspond to a different priority level or set of priority levels. The tag processing hardware 140 may place each incoming instruction into one of the instruction queues based on a priority level associated with the incoming instruction. To fetch an instruction to be checked, the tag processing hardware 140 may attempt to dequeue the highest priority queue first. If that queue is empty, the tag processing hardware 140 may attempt to dequeue the next highest priority queue, and so on. In this manner, some instructions may be checked out of order. For instance, a later arriving instruction with a higher priority level may be checked before an earlier arriving instruction with a lower priority level. Within a same priority level, instructions may be checked according to an order in which the instructions arrive.

The multiple instruction queues may be implemented in any suitable manner. As an example, the multiple instruction queues may be implemented as physically separate queues. As another example, a single physical queue may be used to implement multiple virtual queues. Each virtual queue may have associated modifiable write and read pointers, where the write pointer may be used for enqueuing, and the read pointer may be used for dequeuing.

The inventors have recognized and appreciated that, while checking instructions out of order may reduce exception latency, inconsistencies may arise in some situations. For instance, checking an earlier arriving, but lower priority level, instruction may cause a metadata update that may have some bearing on whether a later arriving, but higher priority level, instruction should be allowed. If the later arriving instruction is checked before the earlier arriving instruction, that check may reference metadata that is out of date. As a result, the later arriving instruction may be allowed even though the check may have failed if the earlier arriving instruction had been checked first.

Accordingly, in some embodiments, techniques are provided for reducing exception latency while checking instructions in order. As an example, a plurality of thresholds may be provided for an instruction queue. Unlike the illustrative second and fourth thresholds in the example of FIG. 3B, which may be used to trigger different actions (e.g., disabling vs. restoring memory access), the plurality of thresholds in this example may be used to trigger a same action (e.g., asserting a signal to stall the host processor 110). At any given point in time, a threshold selected from the plurality of thresholds may be in effect. Such a threshold may be selected based on a priority level of one or more instructions arriving at that time.

It should be appreciated that the techniques introduced above and described in greater detail below may be implemented in any of numerous ways, as the techniques are not limited to any particular manner of implementation. Examples of implementation details are provided herein solely for illustrative purposes. Furthermore, the techniques disclosed herein may be used individually or in any suitable combination, as aspects of the present disclosure are not limited to using any particular technique or combination of techniques.

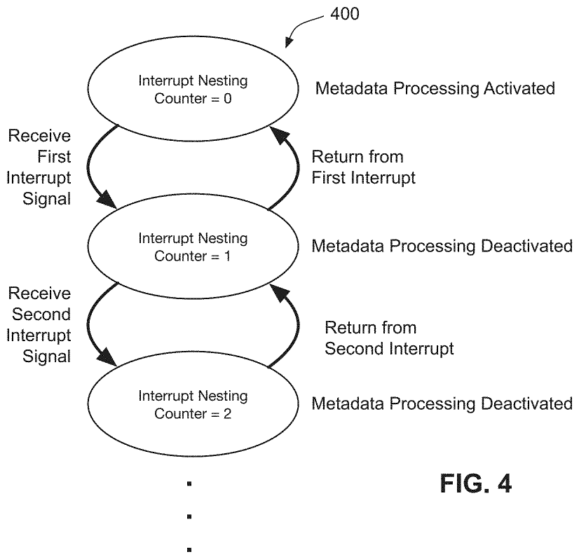

FIG. 4 shows an illustrative state machine 400 for managing metadata processing in response to exception signals, in accordance with some embodiments. The state machine 400 may be used by the illustrative hardware interface 300 in the example of FIG. 3A to determine when to activate or deactivate metadata processing.

In some embodiments, the hardware interface 300 may maintain state information (e.g., using a counter) to keep track of nesting of exceptions. For instance, the counter may be initialized to an initial value (e.g., 0). The hardware interface 300 may examine a trace received via a host processor trace interface to determine if the host processor 110 has received an exception signal that is deemed latency sensitive. In response to determining that the host processor 110 has received such an exception signal, the hardware interface 300 may increment the exception nesting counter to a first value (e.g., 1). In response to detecting a non-zero value in the exception nesting counter, the hardware interface 300 may deactivate metadata processing. For example, the hardware interface 300 may stop sending instructions to the illustrative tag processing hardware 140 via a tag processing trace interface.

In some embodiments, while executing exception handler code for a first exception signal, the host processor 110 may receive a second exception signal. If a priority level of the second exception signal is higher than that of the first exception signal, the host processor 110 may pause the exception handler code for the first exception signal, and may execute exception handler code for the second exception signal. Upon returning from the exception handler code for the second exception signal, the host processor 110 may resume the exception handler code for the first exception signal.

In some embodiments, for any first value N>0 (e.g., N=1), in response to determining that the host processor 110 has paused a first exception handler and begun a second exception handler (e.g., because the first exception handler is of lower priority than the second exception handler), the hardware interface 300 may increment the exception nesting counter to a second value (e.g., N+1=1+1=2). When the host processor 110 returns from the second exception handler (which is of higher priority), the hardware interface 300 may decrement the exception nesting counter back to the first value N (e.g., N=1). Meanwhile, metadata processing may continue to be deactivated.

In some embodiments, when the exception nesting counter is at the first value (e.g., 1), and the host processor 110 returns from exception handler code, the hardware interface 300 may decrement the exception nesting counter back to the initial value (e.g., 0). In response to detecting the initial value in the exception nesting counter, the hardware interface 300 may reactivate metadata processing. For example, the hardware interface 300 may resume sending instructions to the tag processing hardware 140 via the tag processing trace interface.

The inventors have recognized and appreciated that, while some exceptions may be sensitive to latency (e.g., those related to sensor triggers), others may be less so. For instance, some exceptions may be used to offload processor software from polling various peripherals for status. Such an exception may be handled with some delay without causing an undesirable effect. Accordingly, in some embodiments, only selected types of exceptions may trigger deactivation of metadata processing. In this manner, a higher level of security may be maintained.

In some embodiments, a configuration file may be provided as part of a target description that is used by the illustrative policy linker 225 in the example of FIG. 2 to generate an initialization specification, which in turn may be provided to the illustrative policy processor 150 in the example of FIG. 1. The configuration file may include information indicating one or more exceptions that are sensitive to latency. The policy processor 150 may use this information to program a table in the hardware interface 300.

In some embodiments, a host processor trace interface may expose exception entry information to the hardware interface 300. For instance, for an ARM Cortex® device, ETMA[87:78] may indicate a type of an exception signal that is being handled. This exception type information may be used by the hardware interface 300 to look up the table programmed by the policy processor 150, to determine whether the exception signal should trigger deactivation of metadata processing.

Additionally, or alternatively, a host processor trace interface may expose exception return information to the hardware interface 300. For instance, for an ARM Cortex® device, ETMA[76] (exception_rtn) may indicate the host processor 110 is returning from exception handler code. The inventors have recognized and appreciated that exception handler code for exceptions that are latency sensitive tend to be carefully crafted (e.g., written directly in an assembly language to optimize consumption of processor cycles). Allowing such code to execute without being checked by the tag processing hardware 140 may not lead to undue compromise of security.

However, in some instances, it may be desirable to have the tag processing hardware 140 check exception handler code even for exceptions that are latency sensitive. For example, exception handler code may sometimes make a call to other code. An attacker may be able to modify the other code, and then trigger an exception signal to cause execution of the modified code. Accordingly, in some embodiments, techniques are provided for prioritized checking of exception handler code.

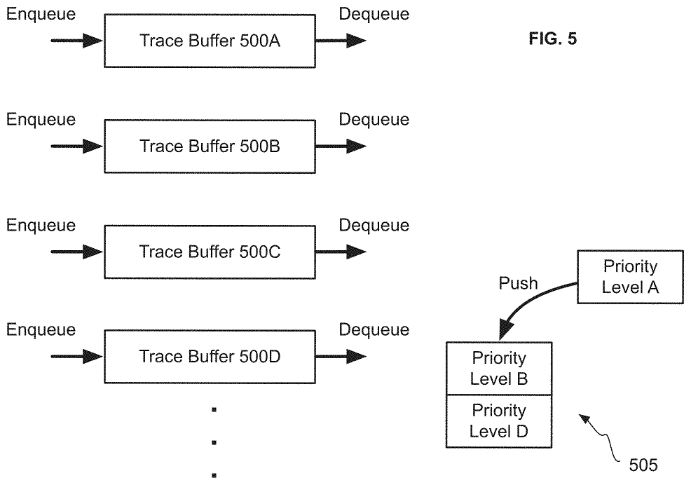

FIG. 5 shows illustrative trace buffers 500A-D and an illustrative exception priority stack 505, in accordance with some embodiments. The trace buffers 500A-D and/or the exception priority stack 505 may be used by the illustrative hardware interface 300 in the example of FIG. 3A to prioritize checking of exception handler code.

In some embodiments, the hardware interface 300 may be configured to place instructions to be checked by the illustrative tag processing hardware 140 into multiple trace buffers. Such instructions may have been received directly from the host processor 110, or may be a result of instruction transformation performed the hardware interface 300. In either case, the hardware interface 300 may be configured to place highest priority level instructions (e.g., exception handler code for exception signals that are very sensitive to latency) into the trace buffer 500A, second highest priority level instructions (e.g., exception handler code for exception signals that are moderately sensitive to latency) into the trace buffer 500B, and so on.

The inventors have recognized and appreciated that individual instructions arriving at the hardware interface 300 may not always have priority information attached thereto. Therefore, in some embodiments, a priority level may be inferred for an instruction. For instance, an instruction arriving after an exception signal, but before return from exception handler code for that exception signal, and before any other exception signal, may be considered part of the exception handler code for that exception signal. As such, the instruction may be placed into a trace buffer corresponding to a priority level of the exception signal.

In some embodiments, the exception priority stack 505 may be used by the hardware interface 300 to determine a trace buffer into which a newly arriving instruction should be placed. For instance, the hardware interface 300 may examine a trace from the illustrative host processor 110 to determine if an exception signal has been received. In response to determining that the host processor 110 has received an exception signal, the hardware interface 300 may push onto the stack 505 a priority level (e.g., priority level D) corresponding to the received exception signal.

In some embodiments, the hardware interface may continue to examine the trace from the host processor 110 to determine if another exception signal has been received. In response to determining that the host processor 110 has received another exception signal, the hardware interface 300 may push onto the stack 505 a priority level (e.g., priority level B) corresponding to the other received exception signal.

Additionally, or alternatively, the hardware interface 300 may examine the trace from the illustrative host processor 110 to determine if there is a return from exception handler code. In response to detecting a return from exception handler code, the hardware interface 300 may pop a priority level from the top of the stack 505.

In this manner, a priority level of an exception signal that is currently being handled by the host processor 110 may be found at the top of the stack 505. The hardware interface 300 may thus place an incoming instruction into a trace buffer corresponding to the priority level at the top of the stack 505. For instance, if priority level A is at the top of the stack 505, an incoming instruction may be placed into the trace buffer 500A.

However, it should be appreciated that aspects of the present disclosure are not limited to inferring a priority level for an instruction. In some embodiments, the host processor 110 may provide priority level information via the host processor trace interface.

The inventors have recognized and appreciated buffering instructions separately based on priority level may advantageously allow differentiated processing based on priority level. As one example, the hardware interface 300 may be configured to send instructions to the tag processing hardware 140 based on priority level. For instance, the hardware interface 300 may be configured to first fetch instructions from the trace buffer 500A. If the trace buffer 500A is empty, the hardware interface 300 may fetch instructions from the trace buffer 500B, and so on.

In this manner, higher priority level instructions (e.g., exception handler code for exception signals that are very sensitive to latency) may be checked by the tag processing hardware 140 before lower priority level instructions (e.g., exception handler code for exception signals that are moderately sensitive to latency), even if the lower priority level instructions arrived at the hardware interface 300 earlier than the higher priority level instructions. This may reduce latency for the higher priority level instructions.

In some embodiments, the tag processing hardware 140 may be configured to check instructions differently based on priority level. For instance, instructions fetched from one or more lower priority level buffers may be checked against a first set of one or more policies, whereas instructions fetched from one or more higher priority level buffers may be checked against a second set of one or more policies different from the first set. The second set of one or more policies may be checked in a more expeditious manner than the first set of one or more policies.

For example, if an instruction is fetched from one or more lower priority level buffers, metadata associated with the instruction and one or more operands may be used to construct a query to look up the illustrative rule table 144 in the example of FIG. 1, which may store rules for the first set of one or more policies. If there is no match, the illustrative policy processor 150 in the example of FIG. 1 may be invoked to perform metadata processing in software, according to the first set of one or more policies.

By contrast, in some embodiments, the second set of one or more policies may be checked entirely in hardware, without invoking the policy processor 150. Additionally, or alternatively, the second set of one or more policies may be checked using only metadata associated with the instruction. Thus, metadata associated with the one or more operands may not be accessed (e.g., from the illustrative metadata memory 125 in the example of FIG. 1).

As an example, instructions fetched from one or more higher priority level buffers may be checked against a set of selected metadata values. For instance, given an instruction fetched from a higher priority level buffer, a tag for an application memory address from which the instruction is fetched may be checked against one or more metadata values corresponding to trusted code (e.g., a trusted exception handler).

Additionally, or alternatively, the second set of one or more policies may be checked without accessing a metadata memory (e.g., the metadata memory 125). For instance, given a higher priority level store instruction (e.g., a store instruction of a trusted exception handler), the tag processing hardware 140 may check the instruction based on metadata associated with a source register of the store instruction, but not metadata associated with a target application memory location of the store instruction. The metadata associated with the source register may be stored the illustrative tag register file 146 in the example of FIG. 1, which may provide faster access than the metadata memory 125, where the metadata associated with the target application memory location may be stored. Thus, latency may be reduced by avoiding a read access to the metadata memory location associated with the target application memory location, while still allowing the metadata associated with the source register to be propagated to that metadata memory location.

Additionally, or alternatively, the tag processing hardware 140 may be configured to use different metadata mappings based on priority level. For instance, with reference to the example of FIG. 1, the tag processing hardware 140 may use the tag map table 142 to map addresses in the application memory 120 to addresses in the metadata memory 125. In some embodiments, an entry in the tag map table 142 may include information indicating a priority level for which the entry is applicable. Thus, an address in the application memory 120 may have a plurality of entries in the tag map table 142, each entry corresponding to one or more respective priority levels of a plurality of priority levels. This may allow a same address in the application memory 120 to be mapped to different addresses in the metadata memory 125 depending on priority level.

For example, an instruction stored at a same address in the application memory 120 (e.g., an instruction of shared library code) may, in some instances, be executed within exception handler code, but, in other instances, be executed outside exception handler code. If the instruction is executed within exception handler code, the hardware interface 300 may place the instruction in a higher priority level buffer (e.g., the trace buffer 500A, 500B, or 500C). If the instruction is executed outside exception handler code, the hardware interface 300 may place the instruction in a lower priority level buffer (e.g., the trace buffer 500D). The tag processing hardware 140 may identify, from the tag map table 142, an entry corresponding to an application memory address from which the instruction is fetched, as well as a trace buffer from which the instruction is fetched. In this manner, different metadata may be associated with a same instruction depending on a priority level of a context in which the instruction is executed. For instance, the same instruction may be afforded a higher level of trust when executed within exception handler code, but a lower level when executed outside exception handler code.

In some embodiments, a register of the host processor 110 may have associated therewith a plurality of entries in the tag register file 146, each entry corresponding to one or more respective priority levels of a plurality of priority levels. Thus, a same register may be mapped to different entries in the tag register file 146 depending on priority level. For instance, in response to receiving an interrupt while executing lower priority code, the host processor 110 may perform a context switch and begin executing interrupt handler code, which may be of higher priority. The context switch may involve storing to the application memory 120 a value from a register used by the lower priority code, so that the value may be restored when the host processor 110 returns from the interrupt handler code. The tag register file 146 may include a first entry storing metadata for use by the tag processing hardware 140 in checking the lower priority code (which was interrupted), and a second entry storing metadata for use by the tag processing hardware 140 in checking the interrupt handler code. In this manner, the tag processing hardware 140 may continue to check instructions of the lower priority code (e.g., instructions queued into a lower priority buffer before the lower priority code was interrupted) even after the context switch.

Similarly, in some embodiments, a program counter of the host processor 110 may have associated therewith a plurality of entries in the tag register file 146, each entry corresponding to one or more respective priority levels of a plurality of priority levels. Thus, the program counter may be mapped to different entries in the tag register file 146 depending on priority level. For instance, with reference to the above context switch example, the tag register file 146 may include a first entry storing metadata for use by the tag processing hardware 140 in checking the lower priority code (which was interrupted), and a second entry storing metadata for use by the tag processing hardware 140 in checking the interrupt handler code. In this manner, the tag processing hardware 140 may continue to check instructions of the lower priority code (e.g., instructions queued into a lower priority buffer before the lower priority code was interrupted) even after the context switch.

It should be appreciated that aspects of the present disclosure are not limited to mapping a same register to different entries in a same tag register file depending on priority level. In some embodiments, a same register may be mapped, based on priority level, to respective entries in different tag register files. For instance, there may be a separate tag register file for each priority level.

In some embodiments, the write interlock 112 may maintain a record of store instructions that have been executed by the host processor 110 but have not been checked by the tag processing hardware 140. The write interlock 112 may be configured to prevent a write operation from proceeding if a target address of the write operation is also a target address of a store instruction in the record. When a store instruction has been checked by the tag processing hardware 140, the write interlock 112 may remove that store instruction from the record.

The inventors have recognized and appreciated that, if lower priority code and higher priority code are checked out of order, a later store instruction of the higher priority code may be checked by the tag processing hardware 140 before an earlier store instruction of the lower priority code. Thus, the later store instruction may be removed from the record of the write interlock 112 before the earlier store instruction.

Accordingly, in some embodiments, the write interlock 112 may maintain priority information in association with store instructions in the record. When a store instruction has been checked by the tag processing hardware 140, the write interlock 112 may remove an oldest entry in the record having priority information corresponding to the priority level of the store instruction.

Additionally, or alternatively, the write interlock 112 may maintain a plurality of records corresponding, respectively, to a plurality of priority levels. When a store instruction has been checked by the tag processing hardware 140, the write interlock 112 may remove an oldest entry in a record corresponding to the priority level of the store instruction.

The inventors have recognized and appreciated that, while using multiple trace buffers to check instructions out of order may reduce exception latency, inconsistencies may arise in some situations. For instance, with reference to the example of FIG. 1, the host processor 110 may execute a first instruction before a second instruction, where the second instruction is part of exception handler code but the first instruction is not. As a result, the second instruction may be placed in a higher priority level buffer (e.g., the trace buffer 500A, 500B, or 500C), while the first instruction may be placed in a lower priority level buffer (e.g., the trace buffer 500D), despite being executed by the host processor 110 before the second instruction.

If the first and second instructions access a same register of the host processor 110, an incorrect policy decision may be possible. For example, checking of the first instruction may cause a metadata update for the shared register. If the second instruction is checked before the first instruction, that check may reference metadata that should have been, but is not yet, updated. As a result, the second instruction may be allowed even though the check may have failed if the first instruction had been checked first, or the second instruction may be disallowed even though the check may have succeeded if the first instruction had been checked first.

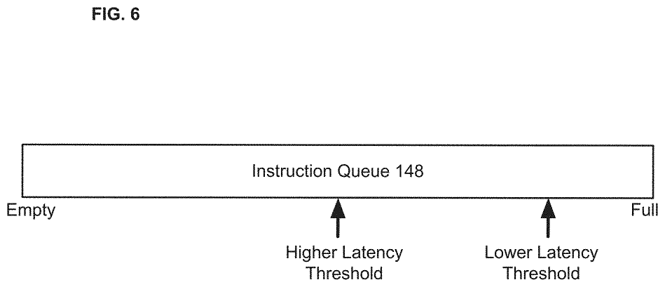

Accordingly, in some embodiments, techniques are provided for reducing exception latency while checking instructions in order. FIG. 6 shows the illustrative instruction queue 148 in the example of FIG. 3A, with a higher latency threshold and a lower latency threshold, in accordance with some embodiments. Unlike the illustrative second and fourth thresholds in the example of FIG. 3B, which may be used to trigger different actions (e.g., disabling vs. restoring memory access for the host processor 110), the higher latency threshold and lower latency thresholds in this example may be used to trigger a same action (e.g., disabling memory access for the host processor 110).

In some embodiments, either the higher latency threshold or the lower latency thresholds may be in effect at any given point in time. For instance, if one or more instructions arriving at the hardware interface 300 from the host processor 110 are part of exception handler code for an exception that is sensitive to latency, the lower latency threshold may be in effect. Otherwise, the higher latency threshold may be in effect.

Thus, when the host processor 110 is not executing exception handler code for an exception that is sensitive to latency, the host processor 110 may be stalled when the instruction queue 148 is filled to the higher latency threshold. In this manner, a portion of the instruction queue 148 (e.g., between the higher latency threshold and the lower latency threshold) may be reserved for exception handler code for one or more exceptions that are sensitive to latency.

Although not show in FIG. 6, similar higher and lower latency thresholds may be provided for the illustrative result queue 114 in the example of 3A, in addition to, or instead of, the higher and lower latency thresholds for the instruction queue 148.

In some embodiments, the write interlock 112 may be configured to allow write transactions generated by selected exception handlers (e.g., those for latency-sensitive exceptions) to proceed without waiting for corresponding instructions to be checked by the tag processing hardware 140. The tag processing hardware 140 may check such an instruction after the fact. If the instruction turns out to violate one or more policies, the tag processing hardware 140 may inform the host processor 110, for example, by asserting an ERROR signal to cause the host processor 110 to halt or reset. In this manner, exception latency may be reduced, while still checking exception handler instructions for policy violations.

As described above in connection with FIG. 1, the illustrative rule table 144 may, in some embodiments, be used to provide a performance enhancement. For instance, the tag processing hardware 140 may query the illustrative policy processor 150 with one or more input metadata tags, and may install a response from the policy processor 150 into the rule table 144, so that the response may later be looked up from the rule table 144 without querying the policy processor 150 again.

The inventors have recognized and appreciated that a miss in the rule table 144 and subsequent querying of the policy processor 150 may lead to exception latency. Accordingly, in some embodiments, one or more policies that are applicable to exception handler code for a latency-sensitive exception may be identified, and rules for the one or more policies may be installed into the rule table 144 ahead of time. For instance, the illustrative policy compiler 220 and/or the illustrative policy linker 225 in the example of FIG. 2 may resolve metadata symbols into binary representations of metadata, and may generate mappings of input metadata tags to output metadata tags for the one or more policies. The illustrative loader 215 may install these mappings into the rule table 144 during initialization.

Additionally, or alternatively, the rule table 144 may be configured to allow selected rules to be locked, such as rules for one or more policies that are applicable to exception handler code for a latency-sensitive exception. This may reduce or eliminate occurrences of rule table misses when the tag processing hardware 140 checks the exception handler code, thereby reducing latency.

Illustrative configurations of various aspects of the present disclosure are provided below.

A1. A computer-implemented method, comprising acts of: receiving trace information regarding one or more instructions executed by a processor, the trace information indicating that the processor is entering an exception handling routine; determining, based on the trace information, a type of exception signal being handled by the processor; determining, based on the type of exception signal being handled by the processor, whether to deactivate metadata processing; and in response to determining that metadata processing is to be deactivated, updating state information to indicate that metadata processing is being deactivated.

A2. The method of configuration A1, wherein: the act of determining whether to deactivate metadata processing comprises: using the type of exception signal being handled by the processor to look up a hardware table; the hardware table stores information indicative of one or more types of exception signals in response to which metadata processing is to be deactivated; and the hardware table is programmed using an initialization specification.

A3. The method of configuration A2, wherein: the initialization specification indicates a threshold priority level; and for each of the one or more types of exception signals in response to which metadata processing is to be deactivated, the initialization specification indicates a priority level that is equal to, or higher than, the threshold priority level.

A4. The method of configuration A1, wherein: the act of updating state information comprises: storing first state information to a selected location, thereby replacing initial state information stored at the selected location; the method further comprises acts of: determining if the initial state information is present at the selected location; and in response to determining that the initial state information is present at the selected location, instructing tag processing hardware to perform metadata processing with respect to the one or more instructions executed by a processor.

A5. The method of configuration A4, wherein: the trace information comprises first trace information; the method further comprises an act of: transforming first trace information into second trace information; and the act of instructing tag processing hardware to perform metadata processing comprises: sending the second trace information to the tag processing hardware.

A6. The method of configuration A1, wherein: the trace information comprises first trace information; the act of updating state information comprises: storing first state information to a selected location, thereby replacing initial state information stored at the selected location; the exception handling routine comprises a first exception handling routine; the type of exception signal comprises a first type of exception signal; and the method further comprises an act of: in response receiving second trace information indicating that the processor is entering a second exception handling routine, storing second state information to the selected location, thereby replacing the first state information.

A7. The method of configuration A6, wherein: the selected location comprises a counter; the act of storing the first state information to the selected location comprises incrementing the counter from an initial value to a first value; and the act of storing the second state information to the selected location comprises incrementing the counter from the first value to a second value.

A8. The method of configuration A1, wherein: the trace information comprises first trace information; the act of updating state information comprises: storing first state information to a selected location, thereby replacing initial state information stored at the selected location; and the method further comprises an act of: in response receiving second trace information indicating that the processor is returning from the exception handling routine, restoring the initial state information to the selected location, thereby replacing the first state information.

A9. The method of configuration A8, wherein: the selected location comprises a counter; the act of storing first state information to a selected location comprises incrementing the counter from an initial value to a first value; and the act of restoring the initial state information to the selected location comprises decrementing the counter from the first value to the initial value.

B1. A computer-implemented method, comprising acts of: receiving trace information from a processor; determining a priority level for the trace information; selecting, based on the priority level for the trace information, a trace buffer from a plurality of trace buffers; and placing one or more instructions into the selected trace buffer, wherein: the one or more instructions are determined based on the trace information received from the processor.

B2. The method of configuration B1, wherein: the act of determining a priority level for the trace information comprises: determining, based on the trace information, whether the processor is entering an exception handling routine; in response to determining that the processor is entering an exception handling routine, using a type of exception signal being handled by the processor to look up a hardware table that indicates respective priority levels for a plurality of types of exception signals.

B3. The method of configuration B2, further comprising an act of: pushing an entry onto an exception priority stack, wherein the entry indicates the priority level for the type of exception signal being handled by the processor.

B4. The method of configuration B3, wherein: the trace information comprises first trace information; the exception handling routine comprises a first exception handling routine; the entry pushed onto the exception priority stack comprises a first entry; and the method further comprises acts of: receiving second trace information from the processor; determining, based on the second trace information, whether the processor is returning from a second exception handling routine; and in response to determining that the processor is returning from a second exception handling routine, popping a second entry from the exception priority stack.

B5. The method of configuration B4, wherein: the second exception handling routine is the first exception handling routine; and the second entry is the first entry.

B6. The method of configuration B1, wherein: the act of determining a priority level for the trace information comprises: determining, based on the trace information, whether the processor is entering, or returning from, an exception handling routine; and in response to determining that the processor is neither entering, nor returning from, an exception handling routine, determining the priority level for the trace information based on a top entry on an exception priority stack.

B7. The method of configuration B1, wherein: the priority level is extracted from the trace information received from the processor.

B8. The method of configuration B1, wherein: the plurality of trace buffers comprise a first trace buffer associated with a first priority level; the plurality of trace buffers further comprise a second trace buffer associated with a second priority level lower than the first priority level; and the method further comprises acts of: attempting to fetch an instruction from the first trace buffer; and attempting to fetch an instruction from the second trace buffer only if the first trace buffer is empty.

C1. A computer-implemented method, comprising acts of: fetching an instruction from a trace buffer of a plurality of trace buffers, wherein: each trace buffer of the plurality of trace buffers has an associated priority level; selecting, based on the priority level of the trace buffer from which the instruction is fetched, a set of one or more policies; and using the selected set of one or more policies to check the instruction.

D1. A computer-implemented method, comprising acts of: fetching an instruction from a trace buffer of a plurality of trace buffers, wherein: each trace buffer of the plurality of trace buffers has an associated priority level; selecting, based on the priority level of the trace buffer from which the instruction is fetched, a metadata mapping; using the selected metadata mapping to obtain metadata; and using the obtained metadata to check the instruction.

D2. The method of configuration D1, wherein: the metadata mapping comprises a tag register file; and the act of using the selected metadata mapping to obtain metadata comprises: accessing the metadata from the selected tag register file.

D3. The method of configuration D1, wherein: the metadata mapping comprises a metadata address mapping; and the act of using the selected metadata mapping to obtain metadata comprises: using the selected metadata address mapping to obtain a metadata address; and accessing the metadata from the metadata address.

E1. A system comprising circuitry and/or one or more processors programmed by executable instructions, wherein the circuitry and/or the one or more programmed processors are configured to perform the method of any of the above configurations.

E2. At least one computer-readable medium having stored thereon at least one netlist for the circuitry of configuration E1.

E3. At least one computer-readable medium having stored thereon at least one hardware description that, when synthesized, produces the netlist of configuration E2.

E3. At least one computer-readable medium having stored thereon the executable instructions of configuration E1.

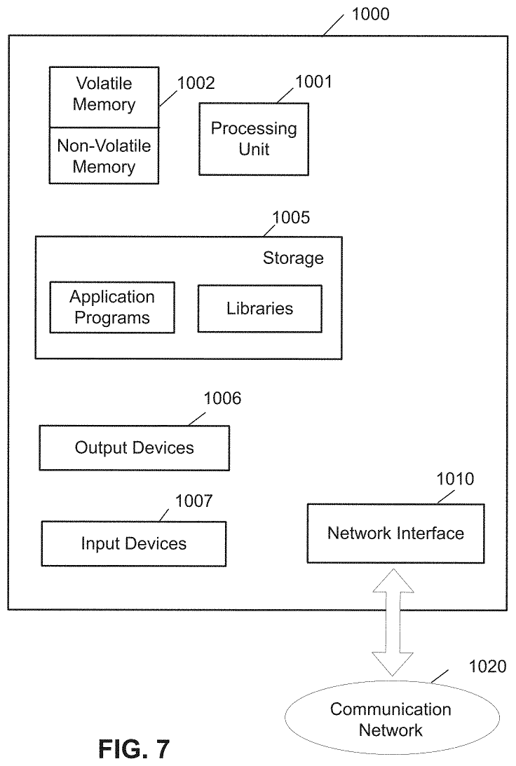

FIG. 7 shows, schematically, an illustrative computer 1000 on which any aspect of the present disclosure may be implemented. In the example shown in FIG. 7, the computer 1000 includes a processing unit 1001 having one or more processors and a computer-readable storage medium 1002 that may include, for example, volatile and/or non-volatile memory. The memory 1002 may store one or more instructions to program the processing unit 1001 to perform any of the functions described herein. The computer 1000 may also include other types of computer-readable medium, such as storage 1005 (e.g., one or more disk drives) in addition to the system memory 1002. The storage 1005 may store one or more application programs and/or resources used by application programs (e.g., software libraries), which may be loaded into the memory 1002.

The computer 1000 may have one or more input devices and/or output devices, such as output devices 1006 and input devices 1007 illustrated in FIG. 7. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 1007 may include a microphone for capturing audio signals, and the output devices 1006 may include a display screen for visually rendering, and/or a speaker for audibly rendering, recognized text. In the example of FIG. 7, the computer 1000 may also include one or more network interfaces (e.g., network interface 1010) to enable communication via various networks (e.g., communication network 1020). Examples of networks include local area networks (e.g., an enterprise network), wide area networks (e.g., the Internet), etc. Such networks may be based on any suitable technology, and may operate according to any suitable protocol. For instance, such networks may include wireless networks and/or wired networks (e.g., fiber optic networks).

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer, or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques disclosed herein may be embodied as a non-transitory computer-readable medium (or multiple non-transitory computer-readable media) (e.g., a computer memory, one or more floppy discs, compact discs, optical discs, magnetic tapes, flash memories, circuit configurations in Field Programmable Gate Arrays or other semiconductor devices, or other tangible computer-readable media) encoded with one or more programs that, when executed on one or more processors, perform methods that implement the various embodiments of the present disclosure described above. The computer-readable medium or media may be transportable, such that the program or programs stored thereon may be loaded onto one or more different computers or other processors to implement various aspects of the present disclosure as described above.

The terms “program” or “software” are used herein to refer to any type of computer code or set of computer-executable instructions that may be employed to program one or more processors to implement various aspects of the present disclosure as described above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium that convey how the fields are related. However, any suitable mechanism may be used to relate information in fields of a data structure, including through the use of pointers, tags, or other mechanisms that how the data elements are related.

Various features and aspects of the present disclosure may be used alone, in any combination of two or more, or in a variety of arrangements not specifically described in the foregoing, and are therefore not limited to the details and arrangement of components set forth in the foregoing description or illustrated in the drawings. For example, aspects described in one embodiment may be combined in any manner with aspects described in other embodiments.

Also, the techniques disclosed herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

What is claimed is:

1. A computer-implemented method, comprising acts of:
receiving trace information regarding one or more instructions executed by a processor, the trace information indicating that the processor is entering an exception handling routine;
determining, based on the trace information, a type of exception signal being handled by the processor;
determining, based on the type of exception signal being handled by the processor, whether to deactivate metadata processing; and
in response to determining that metadata processing is to be deactivated, updating state information to indicate that metadata processing is being deactivated.

2. The method of claim 1, wherein:
the act of determining whether to deactivate metadata processing comprises:
using the type of exception signal being handled by the processor to look up a hardware table;
the hardware table stores information indicative of one or more types of exception signals in response to which metadata processing is to be deactivated; and
the hardware table is programmed using an initialization specification.

3. The method of claim 2, wherein:
the initialization specification indicates a threshold priority level; and
for each of the one or more types of exception signals in response to which metadata processing is to be deactivated, the initialization specification indicates a priority level that is equal to, or higher than, the threshold priority level.

4. The method of claim 1, wherein:
the act of updating state information comprises:
storing first state information to a selected location, thereby replacing initial state information stored at the selected location;
the method further comprises acts of:
determining if the initial state information is present at the selected location; and
in response to determining that the initial state information is present at the selected location, instructing tag processing hardware to perform metadata processing with respect to the one or more instructions executed by a processor.

5. The method of claim 4, wherein:
the trace information comprises first trace information;
the method further comprises an act of:
transforming first trace information into second trace information; and
the act of instructing tag processing hardware to perform metadata processing comprises:
sending the second trace information to the tag processing hardware.

6. The method of claim 1, wherein:
the trace information comprises first trace information;
the act of updating state information comprises:
storing first state information to a selected location, thereby replacing initial state information stored at the selected location;
the exception handling routine comprises a first exception handling routine;
the type of exception signal comprises a first type of exception signal; and
the method further comprises an act of:
in response receiving second trace information indicating that the processor is entering a second exception handling routine, storing second state information to the selected location, thereby replacing the first state information.

7. The method of claim 6, wherein:
the selected location comprises a counter;
the act of storing the first state information to the selected location comprises incrementing the counter from an initial value to a first value; and
the act of storing the second state information to the selected location comprises incrementing the counter from the first value to a second value.

8. The method of claim 1, wherein:
the trace information comprises first trace information;
the act of updating state information comprises:
storing first state information to a selected location, thereby replacing initial state information stored at the selected location; and
the method further comprises an act of:
in response receiving second trace information indicating that the processor is returning from the exception handling routine, restoring the initial state information to the selected location, thereby replacing the first state information.

9. The method of claim 8, wherein:
the selected location comprises a counter;
the act of storing first state information to a selected location comprises incrementing the counter from an initial value to a first value; and
the act of restoring the initial state information to the selected location comprises decrementing the counter from the first value to the initial value.

10. A computer-implemented method, comprising acts of:
fetching an instruction from a trace buffer of a plurality of trace buffers, wherein:
each trace buffer of the plurality of trace buffers has an associated priority level;
selecting, based on the priority level of the trace buffer from which the instruction is fetched, a set of one or more policies; and
using the selected set of one or more policies to check the instruction.

11. A computer-implemented method, comprising acts of:
fetching an instruction from a trace buffer of a plurality of trace buffers, wherein:
each trace buffer of the plurality of trace buffers has an associated priority level;
selecting, based on the priority level of the trace buffer from which the instruction is fetched, a metadata mapping;
using the selected metadata mapping to obtain metadata; and
using the obtained metadata to check the instruction.

12. The method of claim 11, wherein:
the metadata mapping comprises a tag register file; and
the act of using the selected metadata mapping to obtain metadata comprises:
accessing the metadata from the selected tag register file.

13. The method of claim 12, wherein:
the metadata mapping comprises a metadata address mapping; and
the act of using the selected metadata mapping to obtain metadata comprises:
using the selected metadata address mapping to obtain a metadata address; and
accessing the metadata from the metadata address.
